(19) United States
(12) Patent Application Publication
(10) Pub. No.: US 2019/0096216 A1
(43) Pub. Date: Mar. 28, 2019

(54) PERSONAL DISTRESS ALERT SYSTEM AND METHOD

(71) Applicant: Annie Eaton, Bowie, MD (US)

(72) Inventor: Annie Eaton, Bowie, MD (US)

(21) Appl. No.: 16/141,566

(22) Filed: Sep. 25, 2018

Related U.S. Application Data
(60) Provisional application No. 62/562,930, filed on Sep. 25, 2017.

(51) Int. Cl. G08B 21/02; G01S 19/17; G08B 25/10; G06F 3/044

(52) U.S. Cl. CPC G08B 21/02; G06F 3/044; G08B 25/10; G01S 19/17

(57) ABSTRACT

A personal distress alert system includes a main housing attached to a wristband. The main housing contains electronic components including a controller, a global positioning satellite transceiver, an electronic sound producing device, and a power source. The main housing includes a first button and a second button. The first button is configured to activate the electronic sound producing device. The second button is configured to activate the global positioning satellite transceiver. A control center is configured to receive wireless transmission from the personal distress alert system. A user wears the personal distress system on their wrist to indicate distress if attacked or lost.

### CROSS-REFERENCE TO RELATED APPLICATION(S)

The present application is related to and claims priority to U.S. Provisional Patent Application No. 62/562,930 filed Sep. 25, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of security apparel of existing art and more specifically relates to personal security apparel.

### RELATED ART

Individuals in peril may have mere seconds to call for help. During instances where a person is attacked it is not uncommon for the attacker to confiscate all common communication devices. The attacker may subdue the victim, take their phone, or cover their mouth, eliminating all commonly known forms of communication. Under these stressful circumstances it may be useful to give a distress indication without the knowledge of the attacker. Other instances of personal peril include becoming lost. A hiker may become lost in the wilderness, a child may become lost in the city, or an elderly person may become disoriented and stray from their caretaker. A piece of personal security apparel that allows for a user to emit various forms of distress signal may be useful. Existing attempts to provide for a personal security system have failed in this respect.

U.S. Pat. No. 5,742,233 to Mark S. Hoffman relates to a personal security and tracking system. The described personal security and tracking system includes a signaling system that comprises a portable signaling unit, a remote alarm switch device, a central dispatch station, and a wireless communication system such as a cellular or telephone system, etc., and a GPS or alike system. The portable signaling unit and the remote alarm switch may be adapted to be worn at different locations on the person's body. The remote alarm switch may be concealed in the form of a wristband or in the form of any other object such as a broach, pendant, or keychain. When the person in distress activates the remote alarm switch or when the remote alarm switch is removed from the individual by a forceful or unauthorized action or when the signaling unit is removed from the proximity of the remote alarm switch, the portable signaling unit sends a data transmission which includes its location to the central dispatch station. The portable signaling unit also has manual alarm trigger capabilities so it can be used without the remote alarm switch unit. The central dispatch station receives the data transmission and accurately displays the user identification, stored personal information, nature of the alarm; in addition, the location of the portable signaling unit is superimposed on a digitized map at a position corresponding to the location of the person wearing the portable signaling unit. The portable signaling unit can be remotely activated from a central dispatch station to determine and monitor the location of the portable signaling unit.

### SUMMARY OF THE INVENTION

In view of the foregoing disadvantages inherent in the known security apparel art, the present disclosure provides a novel personal distress alert system and method. The general purpose of the present disclosure, which will be described subsequently in greater detail, is to provide an effective and efficient personal distress alert system and method.

A personal distress alert system is disclosed herein. The personal distress alert system includes a wristband, a main housing, a plurality of electronic components, a first button, a second button, and a control-center. The main housing is attached to the wristband. The main housing has a top side, a bottom side, and a perimeter connecting the topside to the bottom side. The plurality of electronic components is located within the main housing. The plurality of electron components include a controller, a global positioning satellite (GPS) transceiver, an electronic sound producing device, and a power source. The power source is configured to deliver electricity to the controller, the global positioning satellite transceiver, and the electronic sound producing device. The first button is disposed on the main housing. The first button is configured to activate the electronic sound producing device. The second button is also disposed on the main housing. The second button is configured to activate the global positioning satellite transceiver. The control-center is capable of receiving wireless communications originating from the personal distress alert system. The personal distress alert system is configured to be worn by a user to provide an alert in an emergency situation via suitable manipulation.

According to another embodiment, a method of using a personal distress alert system is also disclosed herein. The method of using a personal distress alert system includes: providing a personal distress alert system as described above; an attaching the wristband to the wrist of the user; an activating a first button, and alternatively, a second button to signal distress. A further optional step includes, a removing the main housing from the wristband.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a personal distress alert system and method, constructed and operative according to the teachings of the present disclosure.

FIG. 1 is a perspective view of the personal distress alert system during an ‘in-use’ condition, according to an embodiment of the disclosure.

FIG. 2 is a perspective view of the personal distress alert system of FIG. 1, according to an embodiment of the present disclosure.

FIG. 3 is a perspective view of the personal distress alert system of FIG. 1, according to an embodiment of the present disclosure.

FIG. 4 is a perspective view of the personal distress alert system of FIG. 1, according to an embodiment of the present disclosure.

FIG. 5 is a flow diagram illustrating a method of using a personal distress alert system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to security apparel and more particularly to a personal distress alert system and method as used to improve the use of security apparel.

Generally, the disclosed personal distress alert system is a small wristwatch-like device capable of improving personal safety. The device is wearable and concealed as a conventional wristwatch. The device features a number of operation modes to assist the wearer in the event of an emergency. The watch face may be tinted and include a flexible band to apply around the wrist. The watch face may further include a light source, that may function as a flashlight.

The device may be able to emit a loud, audible alarm to deter an attacker and provide indication to other people nearby that assistance is required. The device may also be able to emit a silent alarm to call emergency services such as police or an ambulance. The recipients of the silent alarm may also be programmed to include friend and family. The system may also include a GPS tracker to prevent kidnapping or people becoming lost while outdoors.

In various embodiments, the personal distress alert system may include a liquid crystal display screen. The liquid crystal display screen may be useful to display alert settings, time, and other programming. In further embodiments, the personal distress alert system may include a SIM card adapter, and a microphone. The SIM card allows a user to connect the personal distress alert system to existing cellular infrastructure. The microphone, in this case, may allow the user to send voice messages via the cellular towers. The microphone may further allow a user to create personalized distress call messages, take notes, and effectively function as a personal digital assistant.

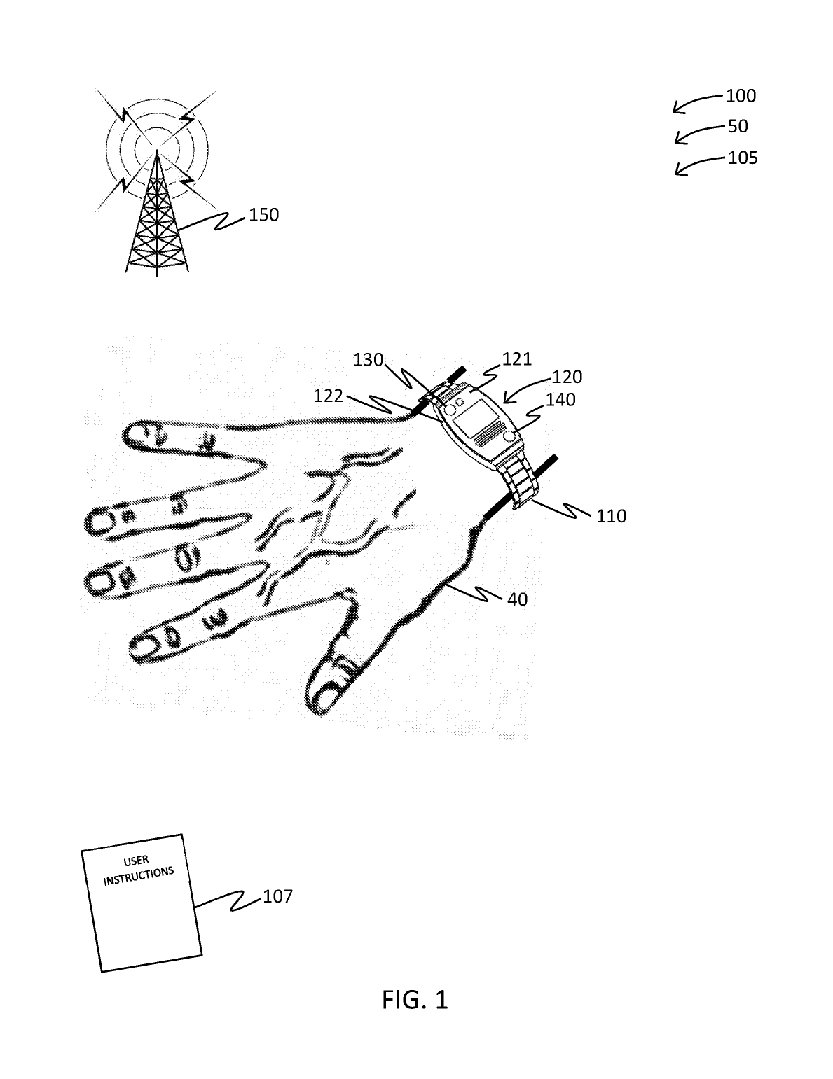

Referring now more specifically to the drawings by numerals of reference, there is shown in FIGS. 1-4, various views of a personal distress alert system 100.

FIG. 1 shows a personal distress alert system 100 during an ‘in-use’ condition 50, according to an embodiment of the present disclosure. Here, the personal distress alert system 100 may be beneficial for use by a user 40 to produce a distress alert. As illustrated, the personal distress alert system 100 may include a wristband 110, a main housing 120, a plurality of electronic components (not shown), a first button 130, a second button 140, and a control-center 150. The main housing 120 is attached to the wristband 110. The main housing 120 has a top side 121, a bottom side (not shown), and a perimeter 122 connecting the top side 121 to the bottom side (not shown). The plurality of electronic components (not shown) are located within the main housing 120. The plurality of electronic components (not shown) include a controller, a global positioning satellite (GPS) transceiver, an electronic sound producing device, and a power source. The power source is configured to deliver electricity to the controller, the global positioning satellite transceiver, and the electronic sound producing device. The first button 130 is disposed on the main housing 120. The first button 130 is configured to activate the electronic sound producing device. The second button 140 is also disposed on the main housing 120. The second button 140 is configured to activate the global positioning satellite transceiver. The control-center 150 is capable of receiving wireless communications originating from the personal distress alert system 100. The personal distress alert system 100 is configured to be worn by a user 40 to provide an alert in an emergency situation via suitable manipulation.

According to one embodiment, the personal distress alert system 100 may be arranged as a kit 105. In particular, the personal distress alert system 100 may further include a set of instructions 107. The instructions 107 may detail functional relationships in relation to the structure of the personal distress alert system 100 such that the personal distress alert system 100 can be used, maintained, or the like, in a preferred manner.

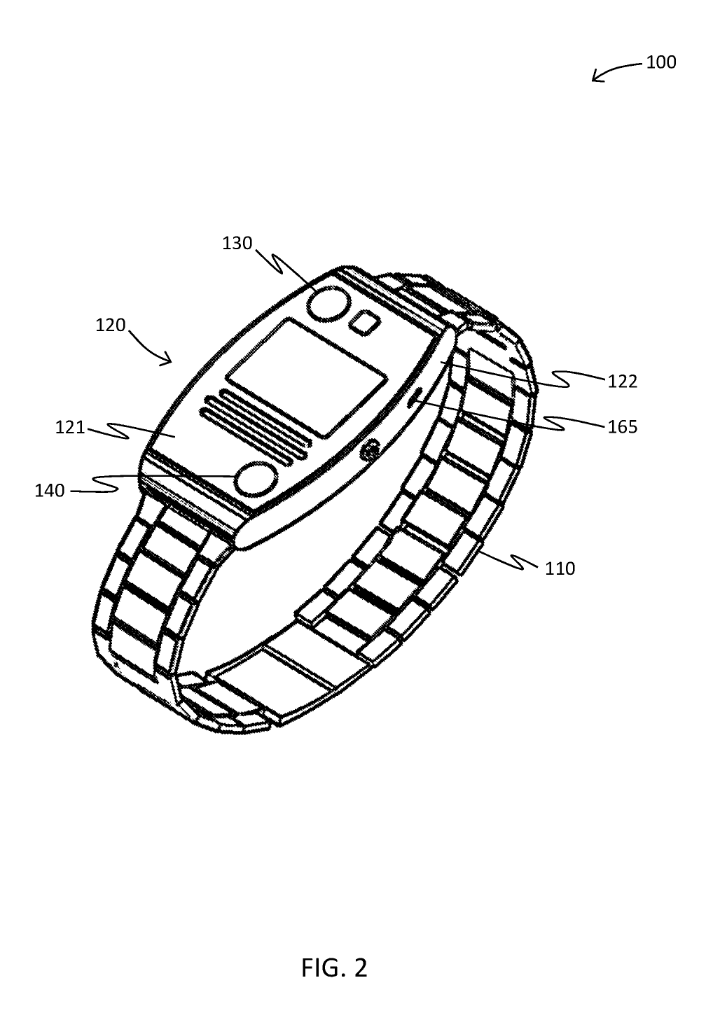

FIG. 2 shows the personal distress alert system 100 of FIG. 1, according to an embodiment of the present disclosure. As above, the personal distress alert system 100 may include a wristband 110, a main housing 120, a plurality of electronic components (not shown), a first button 130, a second button 140, and a control-center 150 (FIG. 1). The main housing 120 is attached to the wristband 110. The main housing 120 has a top side 121, a bottom side (not shown), and a perimeter 122 connecting the top side 121 to the bottom side (not shown). The plurality of electronic components (not shown) are located within the main housing 120. The plurality of electronic components (not shown) include a controller, a global positioning satellite (GPS) transceiver, an electronic sound producing device, and a power source. The power source is configured to deliver electricity to the controller, the global positioning satellite transceiver, and the electronic sound producing device. The perimeter 122 of the main housing 120 may include a micro-USB port 165. The micro-USB port 165 may be used to charge the power source. The micro-USB port 165 may further be in communication with the controller to enable firmware programming. The first button 130 is disposed on the main housing 120. The first button 130 is configured to activate the electronic sound producing device. The second button 140 is also disposed on the main housing 120. The second button 140 is configured to activate the global positioning satellite transceiver. The personal distress alert system 100 may further comprise a liquid crystal display 160 disposed on the main housing 120. In a preferred embodiment, the liquid crystal display 160 is disposed on the top side 121 of the main housing 120. The liquid crystal display 160 may include a capacitive touch sensor functionality. The capacitive touch sensor functionality may allow a user to manipulate various settings and alert options. The first button 130 and the second button 140 may further be used to manipulate various settings and alert options of the personal distress alert system 100. In an embodiment, a user 40 (FIG. 1) may choose to configure the global positioning satellite transceiver to send coordinates to friends, family, police, fire department, and further conceived recipients. The user 40 may also deactivate the first button 130 and the second button 140 to prevent accidental activation.

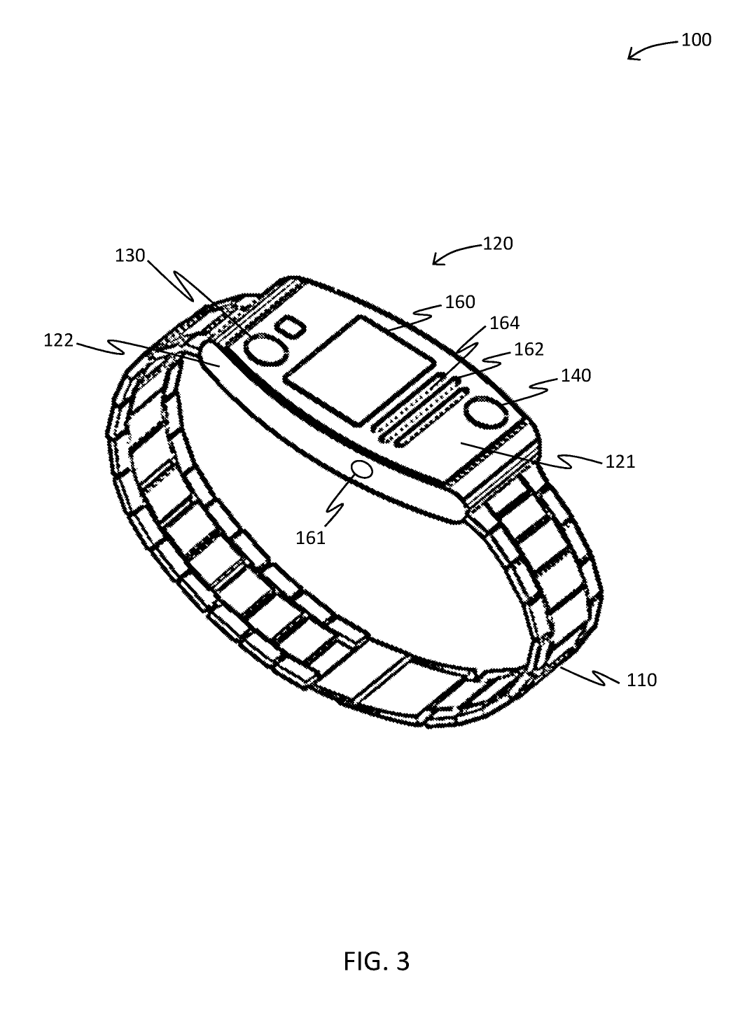

FIG. 3 is another view of the personal distress alert system 100 of FIG. 1, according to an embodiment of the present disclosure. The personal distress alert system 100 may include a wristband 110, a main housing 120, a plurality of electronic components (not shown), a first button 130, a second button 140, and a control-center 150 (FIG. 1). The main housing 120 is attached to the wristband 110. The main housing 120 has a top side 121, a bottom side (not shown), and a perimeter 122 connecting the top side 121 to the bottom side (not shown). In one embodiment, the main housing 120 comprises rigid plastic. In another embodiment, the main housing 120 comprises steel. The plurality of electronic components (not shown) are located within the main housing 120. The plurality of electronic components (not shown) include a controller, a global positioning satellite (GPS) transceiver, an electronic sound producing device, and a power source. The power source is configured to deliver electricity to the controller, the global positioning satellite transceiver, and the electronic sound producing device. The first button 130 is disposed on the main housing 120. The first button 130 is configured to activate the electronic sound producing device. The first button 130 may have capacitive touch sensor functionality. The second button 140 is also disposed on the main housing 120. The second button 140 is configured to activate the global positioning satellite transceiver. The second button 140 may have capacitive touch sensor functionality. The personal distress alert system 100 may further include a third button 161. In a preferred embodiment, the third button 161 is disposed on the perimeter 122 of the main housing 120. The third button 161 may be programmed to interact with the liquid crystal display 160. The personal distress alert system 100 may further include a timer circuit. The timer circuit may be useful for displaying current local time on the liquid crystal display 160.

In one embodiment, personal distress alert system 100 may comprise a carrier for a SIM card (not shown). The carrier for a SIM card (not shown) may enable a user to connect to the existing infrastructure of conventional cellular towers. In another embodiment, the personal distress alert system 100 may include a microphone 162. The microphone 162 may be used to communicate personalized distress calls a with connection to the cellular tower. The microphone 162 may be useful for taking notes, personalizing distress calls, and further conceived wireless communications and uses. The sound producing device may include a speaker 164 disposed on the main housing 120. The microphone 162 and the speaker 164 may work in conjunction with the cellular connectivity to enable a user 40 (FIG. 1) to wirelessly communicate.

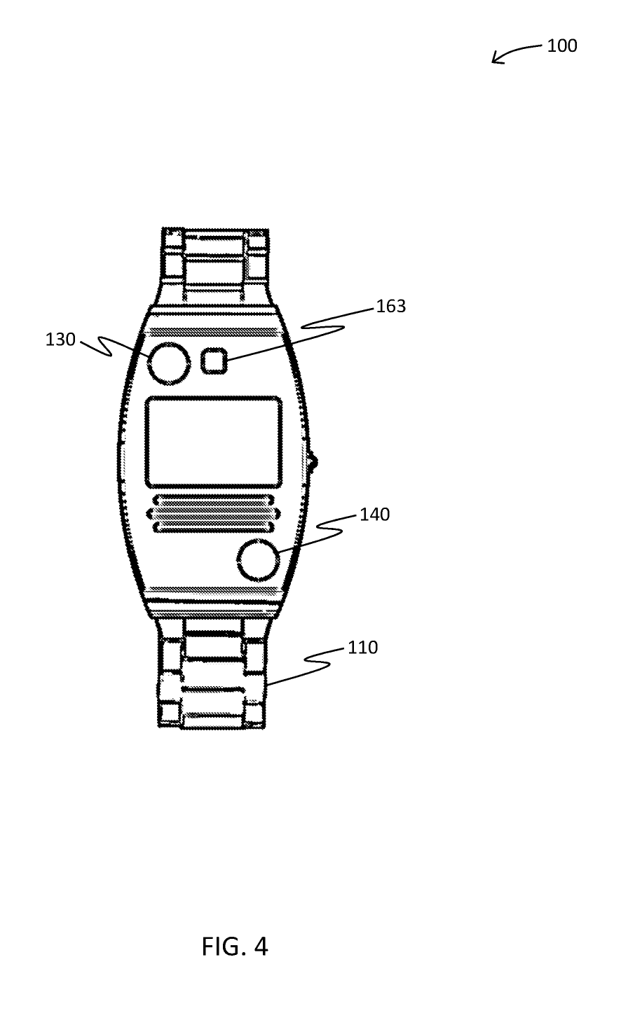

FIG. 4 is another view of the personal distress alert system 100 of FIG. 1, according to an embodiment of the present disclosure. As illustrated, the personal distress alert system 100 may include a wristband 110, a main housing 120 (FIG. 3), a plurality of electronic components (not shown), a first button 130, a second button 140, and a control-center 150 (FIG. 1). The main housing 120 is attached to the wristband 110. In another embodiment, the main housing 120 is removable from the wristband 110. The main housing 120 has a top side 121, a bottom side (not shown), and a perimeter 122 (FIG. 2) connecting the top side 121 to the bottom side (not shown). The top side 121 of the main housing 120 may further contain a light 163. The light 163 may have flashlight 163 functionality. The light 163 may further be configured to illuminate the top side 121 of the main housing 120 for viewing the personal distress alert system 100 in the dark. The plurality of electronic components (not shown) are located within the main housing 120. The plurality of electronic components (not shown) include a controller, a global positioning satellite (GPS) transceiver, an electronic sound producing device, and a power source. The power source is configured to deliver electricity to the controller, the global positioning satellite transceiver, and the electronic sound producing device. The first button 130 is disposed on the main housing 120. The first button 130 is configured to activate the electronic sound producing device. The second button 140 is also disposed on the main housing 120. The second button 140 is configured to activate the global positioning satellite transceiver.

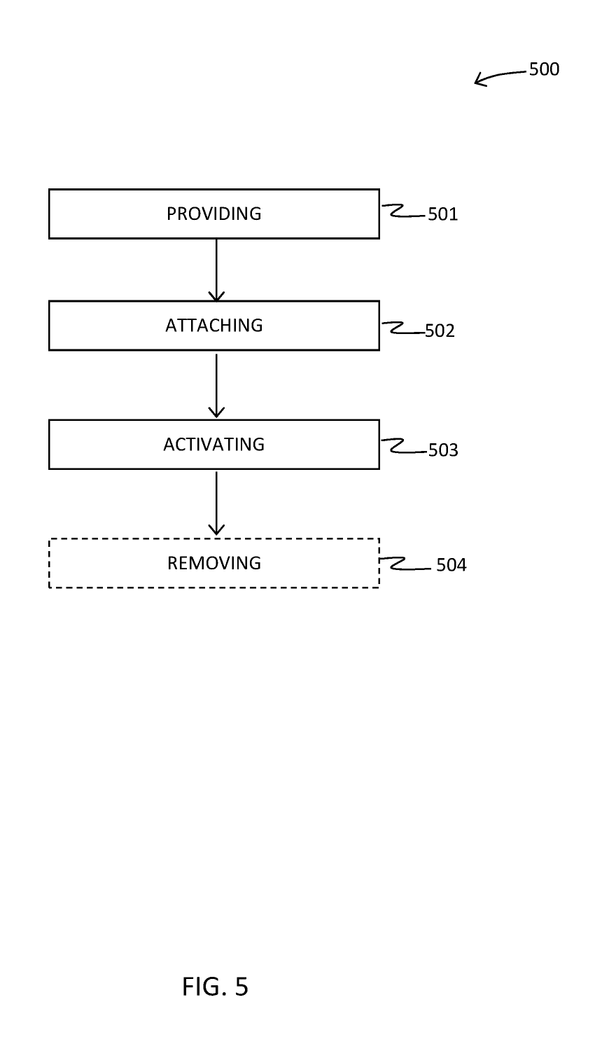

FIG. 5 is a flow diagram illustrating a method for method of using 500 a personal distress alert system 100, according to an embodiment of the present disclosure. In particular, the method for method of using 500 a personal distress alert system 100 may include one or more components or features of the personal distress alert system 100 as described above. As illustrated, the method of using 500 a personal distress alert system 100 may include the steps of: step one 501, providing personal distress alert system comprising: a wristband; a main housing attached to the wristband, the main housing having a top side, a bottom side, and a perimeter connecting the top side to the bottom side; a plurality of electronic components located within the main housing, the plurality of electronic components including a controller, a global positioning satellite (GPS) transceiver, an electronic sound producing device, and a power source configured to deliver electricity to the controller, the global positioning satellite transceiver, and the electronic sound producing device; a first button, the first button is disposed on the main housing, the first button is configured to activate the electronic sound producing device; a second button, the second button is disposed on the main housing, the second button is configured to activate the global positioning satellite transceiver; a control-center, the control-center capable of receiving wireless communications originating from the personal distress alert system; and wherein the personal distress alert system is configured be worn by a user to provide an alert in an emergency situation via suitable manipulation; step two 502, attaching a wristband to wrist of user; step three 503, attaching a wristband to wrist of user; step four 504, removing a ma in housing from a wristband.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for method of using a personal distress alert system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A personal distress alert system comprising:
a wristband;
a main housing attached to said wristband, said main housing having a top side, a bottom side, and a perimeter connecting said top side to said bottom side;
a plurality of electronic components located within the main housing, said plurality of electronic components including a controller, a global positioning satellite (GPS) transceiver, an electronic sound producing device, and a power source configured to deliver electricity to said controller, said global positioning satellite transceiver, and said electronic sound producing device;
a first button, said first button is disposed on said main housing, said first button is configured to activate said electronic sound producing device;
a second button, said second button is disposed on said main housing, said second button is configured to activate said global positioning satellite transceiver;
a control-center, said control-center capable of receiving wireless communications originating from said personal distress alert system; and
wherein said personal distress alert system is configured be worn by a user to provide an alert in an emergency situation via suitable manipulation.

2. The personal distress alert system of claim 1, further comprising a liquid crystal display disposed on said main housing.

3. The personal distress alert system of claim 1, further comprising a carrier for a SIM card.

4. The personal distress alert system of claim 1, further comprising a timer circuit.

5. The personal distress alert system of claim 1, further comprising a third button.

6. The personal distress alert system of claim 1, further comprising a microphone.

7. The personal distress alert system of claim 1, further comprising a light.

8. The personal distress alert system of claim 1, wherein said main housing comprises rigid plastic.

9. The personal distress alert system of claim 1, wherein said main housing comprises steel.

10. The personal distress alert system of claim 1, wherein said sound producing device includes a speaker disposed on said main housing.

11. The personal distress alert system of claim 1, wherein said first button has capacitive touch sensor functionality.

12. The personal distress alert system of claim 1, wherein said second button has capacitive touch sensor functionality.

13. The personal distress alert system of claim 2, wherein said liquid crystal display has capacitive touch sensor functionality.

14. The personal distress alert system of claim 1, wherein said main housing is removable from said wristband.

15. The personal distress alert system of claim 5, wherein said third button is disposed on said perimeter of said main housing

16. The personal distress alert system of claim 1, further comprising a micro-USB port.

17. A personal distress alert system, the personal distress alert system comprising:
a wristband,
a main housing attached to said wristband, said main housing having a top side, a bottom side, and a perimeter connecting said top side to said bottom side,
a plurality of electronic components located within the main housing, said plurality of electronic components including a controller, a global positioning satellite (GPS) transceiver, an electronic sound producing device, and a power source configured to deliver electricity to said controller, said global positioning satellite transceiver, and said electronic sound producing device,
a first button, said first button is disposed on said main housing, said first button is configured to activate said electronic sound producing device,
a second button, said second button is disposed on said main housing, said second button is configured to activate said global positioning satellite transceiver,
a control-center, said control-center capable of receiving wireless communications originating from said personal distress alert system, and
wherein said personal distress alert system is configured be worn by a user to provide an alert in an emergency situation via suitable manipulation;
further comprising a liquid crystal display disposed on said main housing;
further comprising a carrier for a SIM card;
further comprising a timer circuit;
further comprising a third button;
further comprising a microphone;
further comprising a light;
further comprising a micro-USB port;
wherein said main housing comprises rigid plastic;
wherein said sound producing device includes a speaker disposed on said main housing;
wherein said first button has capacitive touch sensor functionality;
wherein said second button has capacitive touch sensor functionality;
wherein said liquid crystal display has capacitive touch sensor functionality;
wherein said main housing is removable from said wristband; and
wherein said third button is disposed on said perimeter of said main housing.

18. The personal distress alert system of claim 17, further comprising set of instructions; and
wherein the personal distress alert system is arranged as a kit.

19. A method of using a personal distress alert system, the method comprising the steps of:
providing a personal distress alert system comprising: a wristband; a main housing attached to said wristband, said main housing having a top side, a bottom side, and a perimeter connecting said top side to said bottom side; a plurality of electronic components located within the main housing, said plurality of electronic components including a controller, a global positioning satellite (GPS) transceiver, an electronic sound producing device, and a power source configured to deliver electricity to said controller, said global positioning satellite transceiver, and said electronic sound producing device; a first button, said first button is disposed on said main housing, said first button is configured to activate said electronic sound producing device; a second button, said second button is disposed on said main housing, said second button is configured to activate said global positioning satellite transceiver; a control-center, said control-center capable of receiving wireless communications originating from said personal distress alert system; and wherein said personal distress alert system is configured be worn by a user to provide an alert in an emergency situation via suitable manipulation;
attaching a wristband to wrist of user; and,
activating a first button, and alternatively, a second button to signal distress;

20. The method of claim 19, further comprising the steps of
removing a main housing from a wristband.
